(19) United States
(12) Patent Application Publication
(10) Pub. No.: US 2012/0131807 A1
(43) Pub. Date: May 31, 2012

(54) Instrument to Measure Vector Height

(76) Inventors: Zhao Zhigang, Zhenjiang (CN); Cai Xiangyou, Zhenjiang (CN)

(21) Appl. No.: 13/308,543

(22) Filed: Dec. 1, 2011

(30) Foreign Application Priority Data
Nov. 30, 2010 (CN) ZL201020632971.5

(51) Int. Cl. G01B 5/02

(52) U.S. Cl. 33/507

(57) ABSTRACT

An instrument to measure vector height comprises a base 8, linear guide rail 10, support and rotating plate 7, slide block 11 on guide rail with a measuring device vertically sliding in the sliding slot of linear guide rail 10 and riser 8 with a top fixed with bumper plate 12. There is a measuring seat 5 for polishing abrasive tools and a rotating clamp handle 6 on a support and rotating plate 7. By changing the corrective blocks on the measuring seat 5 for polishing abrasive tools, the instrument may measure the convexity of abrasive tools, but also the concave areas. Embodiments of the instrument have a wide range of 50 mm, high precision of 0.001 mm and accuracy of 0.006 mm, in a convenient to use form factor.

### RELATED PATENT APPLICATION AND INCORPORATION BY REFERENCE

This is a utility application based upon China patent application Ser. No. ZL 2010 2 0632971.5 filed on flied on Nov. 30, 2010. This related application is incorporated herein by reference and made a part of this application. If any conflict arises between the disclosure of the invention in this utility application and that in the related application, the disclosure in this utility application shall govern. Moreover, the inventor(s) incorporate herein by reference any and all patents, patent applications, and other documents hard copy or electronic, cited or referred to in this application.

### BACKGROUND OF THE INVENTION

(1) Field of the Invention

The invention generally relates to means and methods of measuring the optic lenses and abrasive tools used to shape lenses. More particularly, the invention relates to the measurement of both concave and convex attributes of optic lenses and tools used to carve or grind optic lenses.

(2) The Related Art

A plurality of other single use tools are known in the related art. Such tools measure either a vector height for abrasive lens grinding tools or a vector for a lens surface. In the known related art, separate tools are needed to measure convex values, concave values and to calibrate equipment. None of the known related art tools are capable of making an all in one unit to conveniently measure all of the above described surfaces. Moreover, the related art is rife with handheld devices that are prone to low accuracy. Thus, there is room in the art for the current invention.

### BRIEF SUMMARY OF THE INVENTION

The present invention overcomes shortfalls in the related art by presenting an unobvious and unique combination, configuration of components to construct a system to measure curvatures of both front and back surfaces of optic lenses and the curvatures of abrasive tools and other lens production equipment.

The described instrument overcomes shortfalls in the related art by presenting a single platform and device to measure all curvatures of lenses and lens related tools such as abrasive tools used to grind, crave or polish lenses.

The disclosed system overcomes shortfalls in the art by improving three important factors that dictate the lens diopter values, which are the accuracy of the front and back surfaces of semi-finished lenses, reliability of production equipment and maintaining curvatures of the surfaces of the abrasive tools used in lens production.

### BRIEF DESCRIPTION OF THE DRAWINGS

FIG. 1 depicts a perspective view of one embodiment of the invention

### REFERENCE NUMERALS IN THE DRAWINGS

1 a measuring scale
2 a measuring head
3 a measuring handle
4 a spring guide pole and spring
5 a measuring seat
6 a rotating clamp handle
7 a support and rotating plate
8 a riser or base
9 a riser
10 a linear guide rail
11 slide block
12 bumper plate

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms.

Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

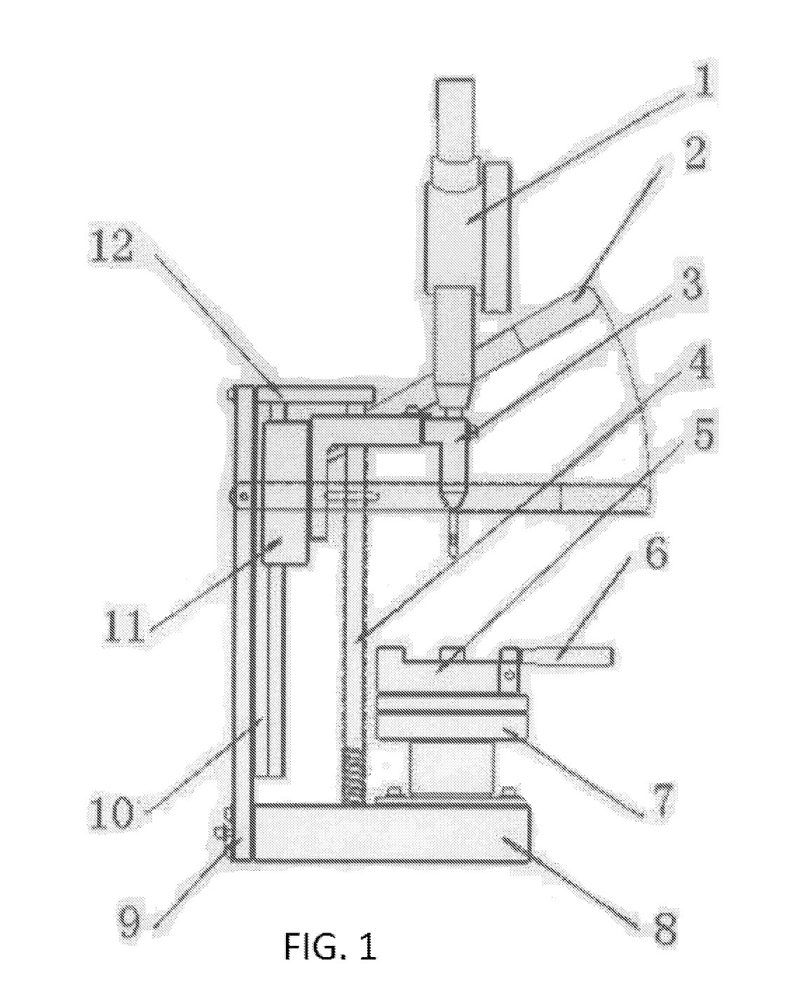

Referring to FIG. 1 disclosed embodiments include a base 8, linear guide rail 10, support and rotating plate 7 on the said base 8, spring and spring guide pole 4. On the side, there is riser 9, on which there is linear guide rail 10. The slide block 11 on the guide rail is with a measuring device vertically sliding in the sliding slot of linear guide rail 10. There is a riser 8, its top is fixed with a bumper plate 12. There are measuring seat 5 for polishing abrasive tools and rotating clamp handle 6 on the measuring seat and rotating plate 7.

Embodiments of the instrument comprise a measuring scale 1, measuring head 2 and measuring handle 3.

Due in part to an unobvious design, a lens measuring seat, corrective blocks for installation, lens measuring and abrasive tools measuring can all be set on the measuring seat 5 for polishing abrasive tools.

The disclosed instrument is not hand-held and measures in a stationary position. It can not only measure the convexity of abrasive tools or the lens, but also the concave attributes of such objects.

The disclosed instrument measures polishing abrasive tools in a prescription lab and convexity of semi-finished products respectively by changing the measuring seat 5 for abrasive tools and lens measuring seat.

The calibration of the instrument is by adjusting corrective blocks for installation, lens measuring and abrasive tools measuring. So there is a high demand for the processing precision of the corrective blocks.

Embodiments of the instrument include the following parts:

1. An instrument to measure vector height includes base 8, linear guide rail 10, support and rotating plate 7 on the said base 8, spring and spring guide pole 4. On the side, there is riser 9, on which there is linear guide rail 10. The slide block 11 on guide rail is with a measuring device vertically sliding in the sliding slot of linear guide rail 10. And for the riser 8, its top is fixed with bumper plate 12. And the feature is that there are measuring seat 5 for polishing abrasive tools and rotating clamp handle 6 on the said support and rotating plate 7.

According to the instrument to measure vector height in part 1, with a measuring scale 1, measuring head 2 and measuring handle 3.

The instrument to measure vector height in part 1, including:

lens measuring seat, corrective blocks for installation, lens measuring and abrasive tools measuring can all be set on the measuring seat (5) for polishing abrasive tools.

Embodiments of the disclosed invention include the following items:

1. A system for measuring both convex and concave attributes of optic lenses and abrasive tools used for modifying optic lenses, the system comprising:

a base supporting a support and rotating plate, a spring and spring guide pole;

the riser supporting a linear guide rail, the linear guide rail supporting a slide block, and the side block supporting a bumper plate; and

the bumper plate supporting a measuring handle and measuring scale.

what is claimed is:

1. A system for measuring both convex and concave attributes of optic lenses and abrasive tools used for modifying optic lenses, the system comprising:
a base supporting a support and rotating plate, a spring and spring guide pole;
the riser supporting a linear guide rail, the linear guide rail supporting a slide block, and the side block supporting a bumper plate; and
the bumper plate supporting a measuring handle and measuring scale.
